(19) United States
(12) Patent Application Publication
(10) Pub. No.: US 2026/0273434 A1
(43) Pub. Date: Sep. 17, 2026

(54) SYSTEMS AND METHODS FOR CONDENSING VAPOR PRODUCT

(71) Applicant: BREAKTHROUGH TECHNOLOGIES, LLC, White Plains, NY (US)

(72) Inventor: Kamal Jaffrey, Winchester, MA (US)

(21) Appl. No.: 19/469,268

(22) PCT Filed: Mar. 27, 2024
(86) PCT No.: PCT/US2024/021609

§ 371 Date: Sep. 25, 2025

Related U.S. Application Data
(60) Provisional application No. 63/492,659, filed on Mar. 28, 2023.

(51) Int. Cl. B01D 5/00

(52) U.S. Cl. CPC B01D 5/009

(57) ABSTRACT

A system for condensing vapor product is provided. The system includes a first duct configured to receive a vapor product, the first duct having a first charge in response to application of a first voltage to the first duct so as to impart a charge on the vapor product. A second duct is configured to allow the vapor product to pass therethrough and configured with a second charge in response to application of a second voltage to thereby allow collection of at least a portion of liquid particles present in the vapor product. A chamber is configured to receive the vapor product and includes a non-conductive pipe including an inner surface, and a conductive pipe changed with the first voltage and positioned within the non-conductive pipe. Methods for condensing vapor are also provided.

### CROSS-REFERENCE TO RELATED APPLICATIONS

This application claims priority under 35 U.S.C. § 119(e) to U.S. Provisional Patent Application No. 63/492,659 filed on Mar. 28, 2023, and entitled “SYSTEMS AND METHODS FOR CONDENSING VAPOR PRODUCT,” the disclosure of which is incorporated herein by reference in its entirety.

### TECHNICAL FIELD

The current subject matter is generally related to systems and methods for condensing vapor product, for example, water vapor condensing systems.

### BACKGROUND

Scavenging water can be a sustainable solution to water scarcity problems in many regions around the world. Desalination is a form of purifying liquid, especially water, and refers to a process that removes some amount of salt and other minerals from saline water. Via desalination, salt water can be converted to fresh water suitable for human consumption, irrigation, or other uses. Due to relatively high-energy consumption, the costs of desalinating seawater are generally higher than the alternatives (e.g., fresh water from rivers or groundwater, water recycling, water conservation, and the like), but alternatives are not always available. Reverse osmosis is another process for purifying water. However, reverse osmosis uses expensive membranes and high-pressures, which requires significant energy.

### SUMMARY

An aspect of the present disclosure provides a system for condensing vapor. The system includes a first duct, a second duct, and a chamber. The first duct is configured to receive a vapor product having a first humidity level, the first duct having a first charge in response to application of a first voltage to the first duct so as to impart a charge on the vapor product. The second duct is in fluid communication with and arranged downstream of the first duct and configured to allow the vapor product to pass therethrough, the second duct having a second charge in response to application of a second voltage that is different than the first voltage to thereby allow collection of at least a portion of liquid particles present in the vapor product. The chamber includes a first end and a second end and in fluid communication with the second duct. The chamber is configured to receive the vapor product therefrom. A non-conductive pipe is positioned within the chamber and extends between the first end and the second end, and includes an inner surface, where at least a portion of the vapor product is configured to condense on the inner surface. A conductive pipe is positioned within the non-conductive pipe, having a third charge in response to application of a third voltage to thereby repel at least a portion of liquid particles present in the vapor product towards the inner surface of the non-conductive pipe.

In some aspects, the system can further include a blower configured to propel the vapor product through at least one of the first duct of the second duct to the chamber.

The chamber can have a variety of configurations. In some aspects, the chamber can include a reservoir configured to receive liquid particles selectively separated from at least the vapor product. In other aspects, the chamber can include a first opening arranged at the first end. In certain aspects, a mesh filter can be arranged within the first opening. In some aspects, the chamber can include a drainage aperture extending through an outer housing of the chamber.

The second duct can have a variety of configurations. In some aspects, the second duct can include an electrode at least partially extending through a channel of the second duct, the spiral electrode being electrically charged with the second voltage. In some aspects, the electrode of the second duct can be a spiral electrode. In certain aspects, the electrode can include a plurality of point electrodes arranged along a length of the electrode.

The non-conductive pipe can have a variety of configurations. In some aspects, the non-conductive pipe can include a wall having apertures defined therein and extending therethrough, the apertures can be configured to direct liquid particles from the at least the vapor product into the reservoir. In some aspects, the non-conductive pipe can include at least one opening to receive the vapor product directly from the second duct.

In some aspects, the vapor product can flow in a cyclonic flow pattern within the chamber.

In some aspects, the conductive pipe can be formed of a conductive mesh.

In another aspect, a method of condensing vapor product is provided. The method includes passing a vapor product through a first duct electrically charged with a first voltage to impart a charge on the vapor product; passing the vapor product through a second duct positioned downstream of and in fluid communication with the first duct, the second duct being electrically charged with a second voltage that is different than the first voltage; passing the vapor product into a chamber, the chamber having a non-conductive pipe including an inner surface, and a conductive pipe electrically charged with a third voltage and positioned within the non-conductive pipe; repelling, by the conductive pipe, at least a portion of liquid particles present in the vapor product radially outward from the conductive pipe; and condensing, by the non-conductive pipe, at least a portion of the vapor product on the inner surface.

The chamber can have a variety of configurations. In some aspects, the chamber can include a first opening arranged at the first end. In certain aspects, a mesh filter can be arranged within the first opening. In some aspects, the chamber can include a drainage aperture arranged radially outward of the non-conductive pipe.

The second duct can have a variety of configurations. In some aspects, the second duct can include an electrode disposed within the second duct, the electrode being electrically charged with the second voltage, where passing the vapor product through a second duct includes passing the vapor product across the spiral electrode to allow at least a portion of liquid particles present within the vapor product to collect on the electrode. The collection of the liquid particles selectively separates from the electrode such that the combination of the collection of liquid particles. In certain aspects, the electrode is a spiral electrode.

In some aspects, the vapor product can flow in a cyclonic flow pattern within the chamber.

In some aspects, the conductive pipe can be formed of a conductive mesh.

In some aspects, a reducer can be positioned between the first duct and the second duct, where the method can further include increasing, by the reducer, a flow rate of the vapor product as it passes therethrough and towards the second duct.

In some aspects, the method can further include collecting the liquid particles selectively separated from the vapor product and transferring the collected liquid particles to a reservoir.

In some aspects, the non-conductive pipe can include a wall having apertures arranged defined therein and extending therethrough, the apertures can be configured to direct liquid particles from the at least the vapor product into a reservoir positioned within the chamber.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a schematic view of a system for condensing vapor according to an exemplary aspect of the present disclosure;

FIG. 2 is a side view of the condensing system of FIG. 1;

FIG. 3 is a schematic view of a duct of the condensing system of FIG. 1;

FIG. 4 is a cross-sectional view taken along line 4-4 in FIG. 1 of a condenser of the condensing system of FIG. 1 used in a system for condensing vapor product according to an exemplary aspect of the present disclosure; and

FIG. 5 is a cross-sectional view taken along line 5-5 in FIG. 4 of the condenser of FIG. 4.

### DETAILED DESCRIPTION

The current subject matter can provide a safe and energy efficient technology to condense and collect water (e.g., in the liquid phase) from one or more vapor products (e.g., a vapor-phase and/or condensed-phase of material (e.g., water) suspended in a stationary or moving mass of air or some other gas carrier) by applying an electrical field between a source electrode and a sink electrode to drive the one or more vapor products along the electrical field. By creating an electrical field and driving the one or more vapor products, without ionizing the one or more vapor products with a high voltage electrical source, the system can be implemented to be safer, have higher efficiency, and produce water with fewer impurities, as compared to some conventional approaches. Exemplary applications include a turbine cooling tower and combustion smoke stack. Existing infrastructures may be retro-fitted and integrated using the current subject matter.

Techniques of scavenging water droplets (e.g., liquid particles of water) from air (e.g., ambient air) can include collectors in the form of wire meshes, and the condensation relies on inertial collision of the water droplets onto the collector meshes for water capture. The use of wire meshes alone can be limited by aerodynamic drag forces since water droplets may be required to collide with the wire meshes.

A problem associated with previous approaches to condensing and collecting water may be solved by utilizing electrical forces. The water (e.g., a vapor-phase and/or liquid-phase of water) in the carrier gas (e.g., air) may be electrically charged and directed toward a collector by an imposed electric field. When the water is electrically charged, it can be attracted to a collector that is charged with an opposite charge. Therefore, the charged water can collide with surfaces of the collector meshes with an increased probability. Upon impact, water droplets can stick to the mesh and coagulate with other incoming water droplets. As a result, when the coagulated water droplets become sufficiently large and heavy on the collector mesh, the water droplets may precipitate due to gravity (e.g., separate from the collector mesh), and the precipitating water droplets may be collected in a reservoir.

There may be a number of different means to scavenge water (e.g., in the liquid-phase) from one or more vapor products. In some conventional approaches that utilize electrical forces for collecting water, corona discharge may be used to introduce a space charge into the water to impart a net charge to the incoming water droplets. Corona discharge may be produced by using a sharp metallic needle that is connected to a high-voltage generator. Typically, voltages to produce stable corona discharge ranges from −10 kV to −24 kV.

However, using corona discharge to impart electrical charges to water may present problems. For example, corona discharge ionizes surrounding air, and can produce gases such as ozone (O₃) and nitric oxide (NO). Nitric oxide can be further oxidized to form nitrogen dioxide (NO₂) and subsequently nitric acid (HNO₃) through photochemical reactions. These gases and liquids are toxic, corrosive, and environmentally harmful. If the water vapor condensing system includes the corona discharge system, what is collected at the collector is corrosive and toxic acid. As a result, the collected liquid requires further treatment if it is desired to be used for useful purposes. In addition, the corona discharge system, when implemented for water vapor condensing system, may be dangerous due to the high voltage associated therewith, may waste large amount of energy, and/or may interfere neighboring electronic instruments due to the high voltage discharges. Moreover, the corona discharge system poses a concern for explosion when the system is surrounded by debris with high surface areas (e.g., dust particles) and/or loose articles.

In some implementations of the present disclosure, an electric field may be applied within a predefined space to direct and collect the water (e.g., liquid particles of water) from one or more vapor products. In a system using the electric field to scavenge water (e.g., liquid particles of water) from one or more vapor products, the system may not require a high voltage generator, and thus, the surrounding air may not be ionized. Since the dielectric breakdown voltage of air is relatively high, at about 3 kV/mm, a substantial electric field may be applied within the predefined space to drive the one or more vapor products to a particular location (e.g., a sink electrode) where the water present within the one or more vapor products may be coagulated and collected. Consequently, toxic and corrosive gases and liquids are not produced. The system can be implemented to be safer than the corona discharge system, has better energy utilization efficiency, and moreover, produces water with fewer impurities to allow the collected water to be directly used (e.g., without further processing or purification). Since the system relies on the polar nature of water molecules, the system may discriminate polar vapor products (e.g., water) from non-polar vapor products (e.g., dust), and thereby producing condensed water with fewer impurities.

In some implementations, a further benefit of the current subject matter can include pollution reduction. Industrial cooling equipment which can emit vapor productized vapor containing chemical and/or biological pollutants. For example, a cooling tower can emit particulate matter, volatile organic compounds, and other toxic air contaminants as a result of dissolved solids in the cooling tower circulation water. These pollutants can become entrained in the air and/or water (e.g., water in the gas-phase or liquid-phase) that is discharged from the cooling tower. In some aspects, the air and/or water emitted from the cooling tower can also include thermal pollutants. For example, the air and/or water emitted from a cooling tower can be emitted at a higher temperature compared to the temperature of the environment in which the cooling tower is located. Elevated temperature emissions can negatively impact the localized environment by altering the thermodynamic conditions of the environment. For example, the elevated temperature emissions can act as a catalyst for chemical and biological pollutants which can also be present in the environment or which were previously existing in the environment and can cause the chemical and biological pollutants to increase in concentration, reaction kinetics, likelihood of dispersion, or the like.

Some implementations of the systems described herein can mitigate thermal, chemical, and/or biological pollution by scavenging water from the emitted one or more vapor products from the cooling tower and maintaining the scavenged water within a closed-loop system coupled to the vapor product emission source. Chemical and biological pollutants can be removed from the emitted vapor products using the system described herein causing these types of pollutants to be retained within the cooling tower circulation system and not emitted into the ambient environment. In addition, some implementations of the systems described herein can reduce thermal pollution by directing high temperature vapor product emissions into the cooling tower circulation, thereby utilizing the thermal mass of the water or cooling medium circulating within the cooling tower system to reduce elevated temperatures of emitted vapor products.

As the world's population continues to rise, and climate change reduces water availability, water scarcity has become one of the most critical issues of our time. Around the world, industrial cooling towers, which use water to extract heat created during manufacturing processes, require a significant amount of water. It is estimated that there are as many at two million cooling towers in the United States alone. A mid-sized tower can lose up to one hundred million gallons of water each year. Traditional cooling towers use water to extract waste heat and eject it into the atmosphere. In these towers humid air carries warm water vapor out of the tower, which is called a plume. Many cooling towers also utilize a sump or basin that collects water and impurities that over time lead to corrosion and bacteria growth. These issues are often controlled by adding water and expensive chemicals.

In general, the present disclosure is directed to a system for condensing vapor. The system generally includes a first duct configured to receive a vapor product from a cooling tower, where the first duct imparts a first charge to the vapor product in response to application of a first voltage to the first duct. The vapor product then passes to a second duct in fluid communication with and arranged downstream of the first duct, where the second duct is configured to allow the vapor product to pass therethrough. The second duct has a second charge in response to application of a second voltage that is different than the first voltage to thereby allow collection of at least a portion of liquid particles present in the vapor product passing therethrough. A chamber in fluid communication with the second duct is configured to receive the vapor product therefrom, and include a non-conductive pipe and a conductive pipe. The non-conductive pipe has an inner surface, where at least a portion of the vapor product is configured to condense on the inner surface. The conductive pipe is positioned within the non-conductive pipe, and has a third charge in response to application of a third voltage to thereby repel at least a portion of liquid particles present in the vapor product towards the inner surface of the non-conductive pipe.

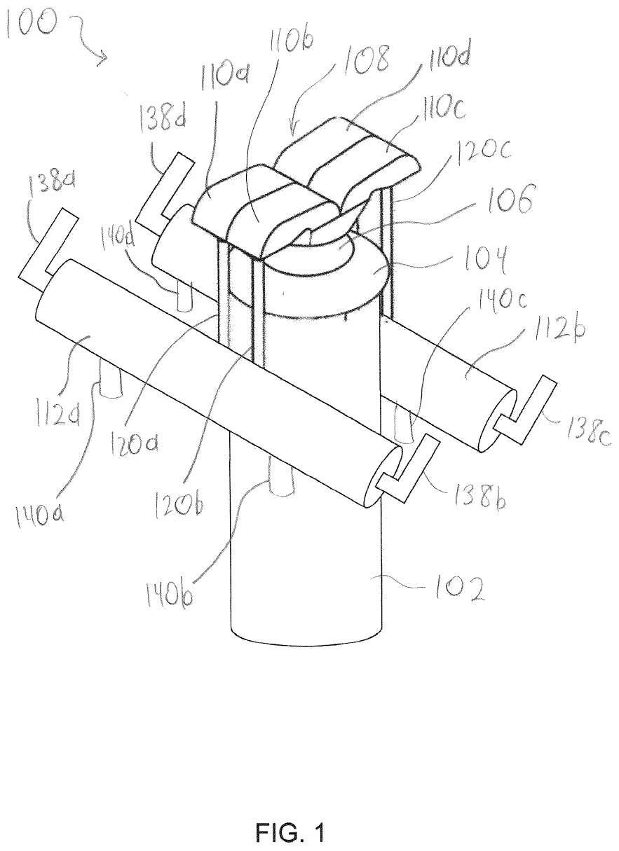

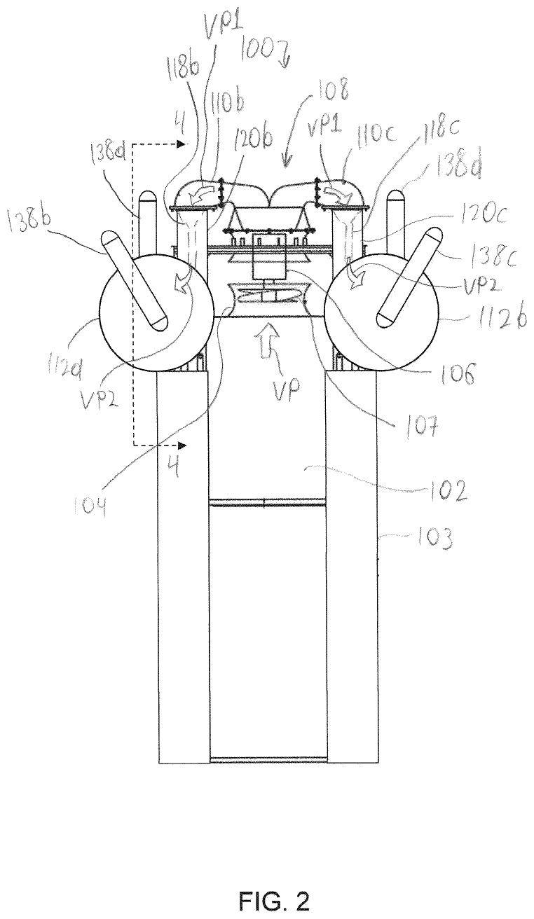

FIG. 1-5 illustrate an exemplary aspect of a system 100 for condensing a vapor product from a cooling tower 102. A vapor product is generated due to a process occurring within the cooling tower 102, or at some location external to the cooling tower 102, with a coolant being passed through a heat exchanger within the cooling tower 102 in order to reduce the coolant temperature. As a byproduct of this heat exchange process, a vapor product, formed from a liquid such as water, is generated and passed upward and out of the cooling tower 102. In some implementations, the vapor product can be in the form of water vapor (e.g., gas-phase molecules). Vapors are typically colorless (e.g., invisible) and non-wetting but can condense and/or react on contact with liquid and/or solid. In some implementations, the vapor product can be in the form of an vapor product (e.g., a visible vapor product containing water droplets (e.g., liquid particles) with a size of about 1 nm to 10 μm or greater (e.g., liquid water particles suspended in a carrier gas, such as air).

The cooling tower 102 includes a reaction chamber where the heat exchange process occurs, an opening 104 arranged within the top of the cooling tower 102, and a blower 106 arranged within the opening 104. The heat exchange process can be conducted by any suitable heat exchange process which produces a vapor product. The blower 106 is arranged in the opening in order to produce a vacuum force which aids in directing the vapor product out of the cooling tower 102. The blower 106 can be any form of air movement device, such as a fan 107 or turbine connected to a power source, such as an electric motor.

Arranged on the other side of the blower 106 and configured to receive the vapor product VP from the cooling tower 102 is a duct system 108. The duct system 108 includes ducts 110a, 110b, 110c, 110d arranged above the cooling tower 102. The ducts 110a, 110b, 110c, 110d are each configured to collect a respective portion of the vapor product VP being emitted from the cooling tower 102. The emitted vapor product VP has a first humidity level. A humidity level is the amount of water, either in gaseous or particulate form, which is present within a vapor product. In some aspects, the ducts 110a, 110b are in fluid communication with a chamber 112a arranged downstream of the ducts 110a, 110b. In order to draw the vapor product VP through the system, the ducts 110a, 110b having a first charge in response to application of a first voltage to the ducts 110a, 110b so as to impart a charge on the vapor product VP, modifying to to a vapor product VP1. In some aspects, the ducts 110a, 110b are curved to redirect the vapor product towards the chamber 112a. Additionally, the ducts 110a, 110b are arranged adjacent to each other. While only two ducts are shown connected to the chamber 112a, any number of ducts can be fluidly coupled to the chamber 112a downstream of the cooling tower 102.

Alternatively, or in addition to, the duct system 108 can include additional ducts 110c, 110d that are in fluid communication with at least one chamber 112b. The chamber 112b can be substantially similar to chamber 112a, and therefore common features are not described in detail herein. A person skilled in the art would appreciate that the above description of the ducts 110a, 110b is also applicable to the additional ducts 110c, 110d.

At this stage in the process, the vapor product includes liquid particles of water, which as described in detail below, will be at least partially removed from the vapor product at subsequent stages of the process. As illustrated in FIG. 1, arranged at an outlet ends of the ducts 110b, 110c are reducers 118b, 188c configured to increase the flow rate of the vapor product passing therethough. In some aspects, the reducers 118b, 118c are conical-shaped pipes which have a reduced the cross-sectional area compared to the ducts 110b, 110c in order to increase the speed of the liquid particles within the vapor product VP1. By increasing the speed of the vapor product VP1, the liquid particles within the vapor product VP1 are separated from one another within the vapor product VP1.

Alternatively, or in addition to, reducers 118a, 118d (not shown) can be arranged at the outlet end of the additional ducts 110a, 110d and configured to increase the flow rate of the vapor product pass therethrough. The reducers 118a, 118d can be substantially similar to reducers 118b, 118c, and therefore common features are not described in detail herein. A person skilled in the art would appreciate that the above description of the reducers 118b, 118c is also applicable to the reducers 118a, 118d.

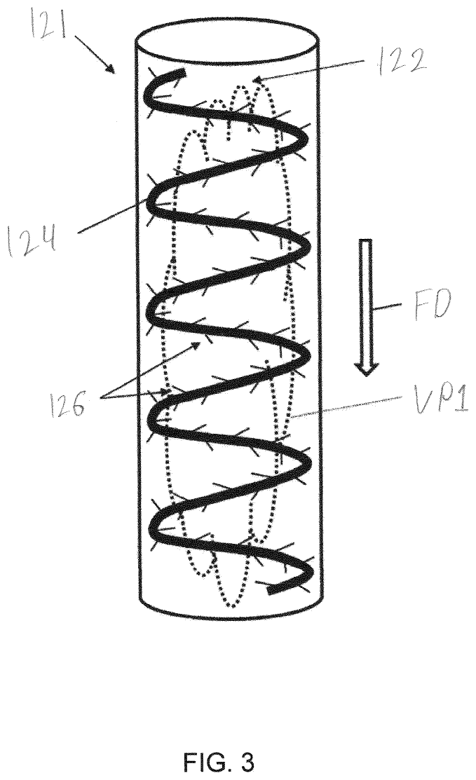

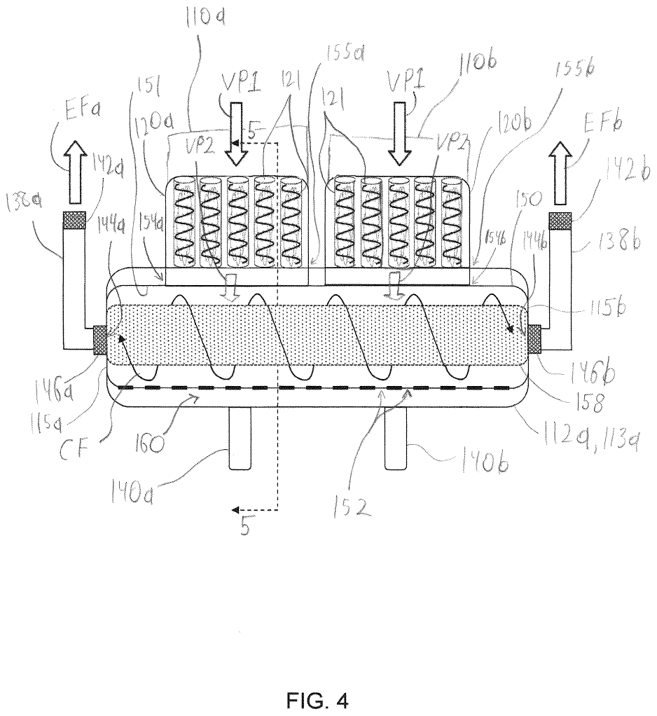

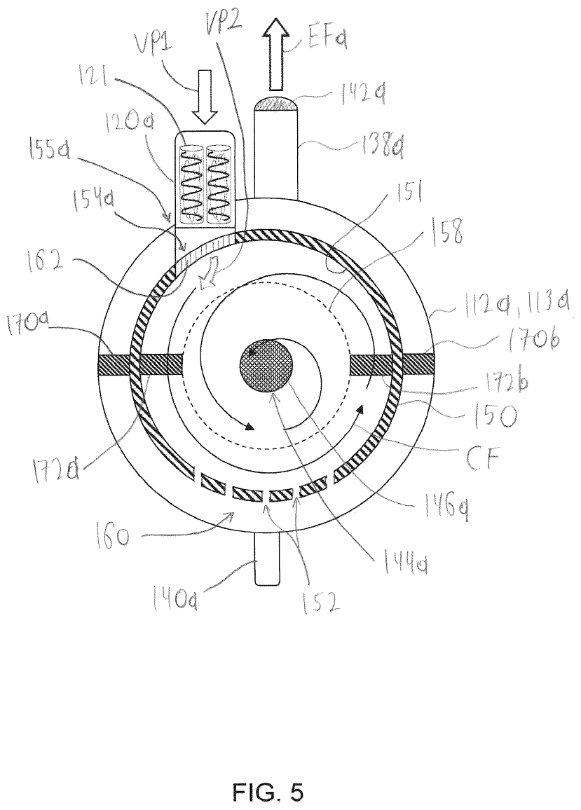

After passing through the reducers 118a, 118b, 118c, 118d the vapor product VP1 passes into second ducts 120a, 120b, 120c, 120d, respectively. The second ducts 120a, 120b, 120c, 120d are arranged downstream of the first ducts 110a, 110b, 110c, 110d. Arranged within each second duct is at least one charger 121 (shown in FIGS. 4-5). A schematic view of the charger 121 is illustrated in FIG. 3. In some aspects, the charger 121 can include an electrode 124 within a passageway 122 for the vapor product to pass therethrough. In use, while the vapor product is passing through the passageway 122, the electrode 124 imparts a different, second charge on the vapor product VP1, modifying it to a vapor product VP2 leaving the second ducts.

The electrode 124 can have a variety of configurations. In this illustrated aspect, the electrode 124 is a spiral electrode. The electrode 124 is shaped such that the electrode extends in a clockwise or counter-clockwise rotation as the electrode extends linearly through the passageway 122. The rotational shape of the electrode 124 is formed in the same direction as the vapor product VP1 spiraling in the flow direction FD to aid in moving the vapor product VP1 through the charger 121 and modifying the it into vapor product VP2. The electrode 124 can include a plurality of point electrodes 126 arranged along the length of the electrode 124. The point electrodes 126 are arranged within the flow path of the vapor product VP1 as it passes through the ducts 120a, 120b, 120c, 120d in order to impart a second charge to the vapor product VP1. The electrode 124 has a second charge in response to application of a second voltage that is different from the first voltage to allow collection of liquid particles present in the vapor product passing through the ducts 120a, 120b, 120c, 120d. By passing the vapor product VP1 through the charger 121, the charger 121 forms a modified vapor product VP2 with a modified humidity level that is greater than the first humidity level. The second voltage is opposite the first voltage such that the liquid particles of the vapor product VP1 are attracted to the ducts 120a, 120b, 120c, 120d from the ducts 110a, 110b, 110c, 110d. As shown in FIGS. 4-5, each duct can include multiple chargers 121 in order to process the vapor product VP1 into the vapor product VP2. In other aspects, any suitable number of chargers can be implemented.

After passing through the ducts 120a, 120b, 120c, 120d, the vapor product VP2 can have liquid removed the vapor product within the chamber 112a, 112b. The chambers 112a, 112b are arranged downstream of the ducts 110a, 110b, 110c, 110d, 120a, 120b, 120c, 120d, and configured to receive the vapor product VP2 from the second ducts 120a, 120b, 120c, 120d. The chambers 112a, 112b can be arranged in a vertical or horizontal configuration, and is configured to pass the vapor product VP2 through various components in order to remove liquid from the vapor product VP2, modifying the vapor product VP2 into an exhaust flow product EFa, EFb. The chambers 112a, 112b are configured to receive the vapor product VP2 from the second ducts 120a, 120b, 120c, 120d.

The chambers can have a variety of configurations. As illustrated in FIGS. 4-5, the chamber 112a includes an outer housing 113a, a non-conductive pipe 150, and a conductive pipe 158. The outer housing can have a variety of configurations. As shown, the outer housing 113a can be substantially cylindrical in shape and extend between a first end 115a and a second end 115b. Defined within and extending through a wall of the outer housing 113a are apertures 155a, 155b that allow the ducts 120a, 120b to pass through the outer housing 113a, and thus, into the chamber 112a.

As further shown, positioned at the first end 115a is an outlet opening 144a and positioned at the second end 115b is an outlet opening 144b. The outlet openings 144a, 144b allow the exhaust flow product EFa, EFb to pass through and out of the chamber 112a through outlets 138a, 138b. In order to further remove liquid from the vapor product, mesh plates 146a, 146b can be arranged on the outlet openings 144a, 144b. In some aspects, the mesh plates 146a, 146b can be charged with the same polarity as the conductive pipe 158 in order to further repel any fluid particles still contained within the exhaust flow product EFa, EFb back into the chamber 112a.

Even further, positioned at the ends of the outlets 138a, 138b are mesh plates 142a, 142b. The mesh plates 142a, 142b can not be electrically charged, and can act as protection from debris or animals from entering the chamber 112a through the outlets 138a, 138b. Additionally, in some aspects, suction fans can be arranged within the outlets 138a, 138b to further provide a motive force to the vapor product.

Also arranged on the outer housing 113a are fluid outlets 140a, 140b. The fluid outlets 140a, 140b are configured to drain coalesced and condensed fluid from the chamber 112a, as discussed below in greater detail. In some aspects, the system can include a reservoir 160 configured to collect the separated liquid from the vapor products VP1 and VP2. In some aspects, as shown in FIG. 4, the reservoir 160 can be positioned underneath the non-conductive pipe 150. Due to the blower 106, the vapor product is moving through the system 100 at an accelerated flow rate. This flow rate could potentially cause additional evaporation to already removed liquid in the reservoir 160 if not properly separated within the chamber 112.

Arranged within the outer housing 113a is the non-conductive pipe 150. The non-conductive pipe 150 can be arranged within the chamber 112a and extend from the first end 115a to the second end 115b. The non-conductive pipe 150 can be cylindrically shaped, and radially inward of the outer housing 113a. The non-conductive pipe 150 includes an inner surface 151, which faces inward towards the conductive pipe 158. Non-limiting examples of suitable material which the non-conductive pipe can be formed from include polyvinyl chloride (PVC), or any other type of suitable plastic or rigid material which is non-conductive.

Defined within and extending through a wall of the non-conductive pipe 150 is a plurality of drainage apertures 152. The drainage apertures 152 pass through the non-conductive pipe 150 and are arranged radially above the reservoir 160. The drainage apertures 152 are configured to allow collected fluid within the non-conductive pipe 150 to pass through the non-conductive pipe 150 and into the chamber 112a. From there, the fluid can be collected in the reservoir 160 and directed from the chamber 112a by the fluid outlets 140a, 140b. In some aspect, the collected fluid can be reused in a cooling process in the cooling tower 102. Also arranged within the non-conductive pipe 150 are apertures 154a, 154b, which are configured to allow the ducts 120a, 120b to pass through the non-conductive pipe 150 such that the vapor product can interact with the inner surface 151 and the conductive pipe 158.

In addition to the chargers 121, the vapor product VP1 also passes through a charged mesh 162 arranged within the aperture 154a to further modify the vapor product VP1 into the vapor product VP2. The charged mesh 162 further imparts a charge on the vapor product to aid in the coalescing of liquid particles from the vapor product, as described below. In some aspects, the charged mesh 162 can have the same polarity as the chargers 121.

Arranged within the non-conductive pipe 150 is a conductive pipe 158. The conductive pipe 158 can be concentrically arranged within the non-conductive pipe 150 and extend from the first end 115a to the second end 115b. The conductive pipe 158 can be cylindrically shaped, and positioned radially inward of the non-conductive pipe 158. The conductive pipe 158 can be formed from a conductive mesh material, where the conductive pipe 158 can have a voltage applied thereto in order to charge the conductive pipe 158. As described in greater detail below, the conductive pipe 158 is formed of a conductive mesh so that the vapor product VP2 can pass through the conductive pipe 158, while also being charged in order to repel any charged vapor particles in the vapor product VP2 towards the inner surface 151 of the non-conductive pipe 150 to aid in collecting liquid from the vapor product VP2 and converting the vapor product VP2 into the exhaust flow product EFa, EFb. Since the gas portion of the vapor product VP2 can pass through the mesh material of the conductive pipe 158, and the vapor particles are repelled away conductive pipe 158, dry gas (e.g., dry air) can pass through the outlet openings 144a, 144b and out the outlets 138a, 138b into the environment. The conductive pipe 150 can be a mesh-type, vane pack, or other structure intended to aggregate the mist into droplets that are heavy enough to separate from the vapor product VP2.

As illustrated in FIG. 5, in order to position the non-conductive pipe 150 within the chamber 112a, supports 170a, 170b are positioned on either side of the non-conductive pipe 150 and extend to contact the outer housing 113a. Additionally, the conductive pipe 158 is also positioned relative to the non-conductive pipe 150 by supports 172a, 172b, which extend from the conductive pipe 158 to the non-conductive pipe 150. The supports 170a, 170b, 172a, 172b can be made from polytetrafluoroethylene (PTFE) or another rigid and non-conductive material.

While not explicitly described, the chamber 112b include substantially similar components compared to the chamber 112a, and as such, like components will not be described in detail. Similar to the chamber 112a, the chamber 112b process a vapor product and removes gas from the vapor product such that dry gas (e.g., dry air) is passed into the environment through outlets 138c, 138d, and the collected fluid is removed from the chamber 112b through drainage outlets 140c, 140d.

In use, a method of condensing a vapor product can be carried out using systems described herein. By way of example, the vapor product VF generated by a cooling tower is passed through the first ducts 110a 100b, which are electrically charged with the first voltage, in order to impart a charge on the vapor product VF. This creates a first modified vapor product VP1. The first modified vapor product VP1 passes through the second ducts 120a, 120b positioned downstream of and in fluid communication with the first ducts 110a, 110b. The second ducts 120a, 120b can be electrically charged with the second voltage that is different than the first voltage, thereby creating a second modified vapor product VP2.

The vapor product VP2 passes into the chamber 112a to remove liquid from the vapor product VP2. When entering the chamber 112a, the vapor product follows through the charged mesh 162 arranged within the aperture 154a to further impart the charge of the chargers 121 onto the vapor product. Once the vapor product enters the chamber 112a, the vapor product VP2 will flow in a cyclonic flow pattern CF illustrated in FIGS. 4-5 since the air is entering the chamber 112a perpendicular to the length of the chamber 112a. The cyclonic flow pattern CF forces the vapor product VP2 to flow both radially inward towards the outlet openings 144a, 144b, while also allowing the vapor product VP2 to move laterally along the chamber 112a towards the outlet openings 144a, 144b. The chamber 112a has non-conductive pipe 150 and the conductive pipe 158. The conductive pipe is electrically charged with the second voltage that is the same as at least the second voltage of the chargers 121. The vapor product VP2 follows the cyclonic flow pattern, which both cools the vapor product VP2 and allows for fluid particles within the vapor product VP2 to coalesce out of the vapor product VP2 and to be repelled by the conductive pipe 158, while also being forced outward due to the centrifugal forces imparted on the vapor product VP2 by the cyclonic flow pattern CF. The repelled fluid particles move radially outward from the conductive pipe 158 and make contact with the inner surface 151 of the non-conductive pipe 150. As the collected fluid increases in volume, the droplets can combine together to form droplets large enough from gravity to pull to the bottom of the non-conductive pipe 150 and through the drainage apertures 152, into the reservoir 160. The dry air by-product from the vapor product VP2 passes through the outlet openings 144a, 144b and out the outlets 138a, 138b as exhaust flow product EFa, EFb.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A system comprising:
a first duct configured to receive a vapor product, the first duct having a first charge in response to application of a first voltage to the first duct so as to impart a charge on the vapor product;
a second duct in fluid communication with and arranged downstream of the first duct and configured to allow the vapor product to pass therethrough, the second duct having a second charge in response to application of a second voltage that is different than the first voltage to thereby allow collection of at least a portion of liquid particles present in the vapor product; and
a chamber having a first end and a second end, the chamber in fluid communication with the second duct and configured to receive the vapor product therefrom, the chamber comprising:
a non-conductive pipe, extending between the first end and the second end, having an inner surface, wherein at least a portion of the vapor product is configured to condense on the inner surface, and
a conductive pipe positioned within the non-conductive pipe, the conductive pipe having a third charge in response to application of a third voltage to thereby repel at least a portion of liquid particles present in the vapor product towards the inner surface of the non-conductive pipe.

2. The system according to any of the preceding claims, wherein the chamber further comprises a reservoir configured to receive liquid particles selectively separated from at least the vapor product.

3. The system according to any of the preceding claims, wherein the non-conductive pipe includes a wall having apertures defined therein and extending therethrough, the apertures configured to direct liquid particles from the at least the vapor product into the reservoir.

4. The system according to any of the preceding claims, wherein the conductive pipe is formed of a conductive mesh.

5. The system according to any of the preceding claims, wherein the second duct comprises an electrode at least partially extending through a channel of the second duct, the spiral electrode being electrically charged with the second voltage.

6. The system according to any of the preceding claims, wherein the electrode is a spiral electrode.

7. The system according to any of the preceding claims, wherein the electrode comprises a plurality of point electrodes arranged along a length of the electrode.

8. The system according to any of the preceding claims, wherein the chamber further comprises a first opening arranged at the first end.

9. The system according to any of the preceding claims, wherein a mesh filter is arranged within the first opening.

10. The system according to any of the preceding claims, wherein the vapor product flows in a cyclonic flow pattern within the chamber.

11. The system according to any of the preceding claims, wherein the non-conductive pipe includes at least one opening to receive the vapor product directly from the second duct.

12. The system according to any of the preceding claims, further comprising a blower configured to propel the vapor product through at least one of the first duct or the second duct to the chamber.

13. The system according to any of the preceding claims, wherein the chamber further includes a drainage aperture extending through an outer housing of the chamber and arranged radially outward of the non-conductive pipe.

14. A method comprising:
passing a vapor product through a first duct electrically charged with a first voltage to impart a charge on the vapor product;
passing the vapor product through a second duct positioned downstream of and in fluid communication with the first duct, the second duct being electrically charged with a second voltage that is different than the first voltage;
passing the vapor product into a chamber, the chamber having a non-conductive pipe including an inner surface, and a conductive pipe electrically charged with a third voltage and positioned within the non-conductive pipe;
repelling, by the conductive pipe, at least a portion of liquid particles present in the vapor product radially outward from the conductive pipe; and
condensing, by the non-conductive pipe, at least a portion of the vapor product on the inner surface.

15. The method according to any of the preceding claims, further comprising directing the vapor product into a cyclonic flow pattern within the chamber.

16. The method according to any of the preceding claims, wherein the non-conductive pipe includes a wall having apertures defined therein and extending therethrough, the apertures configured to direct liquid particles from the at least the vapor product into a reservoir positioned within the chamber.

17. The method according to any of the preceding claims, wherein the conductive pipe is formed of a conductive mesh.

18. The method according to any of the preceding claims, wherein the chamber further comprises a first opening arranged at the first end and a mesh filter is arranged within the first opening.

19. The method according to any of the preceding claims, wherein a reducer is positioned between the first duct and the second duct, and wherein the method further comprises,
increasing, by the reducer, a flow rate of the vapor product as it passes therethrough and towards the second duct.

20. The method according to any of the preceding claims, wherein the second duct comprises an electrode disposed within the second duct, the electrode being electrically charged with the second voltage, and wherein passing the vapor product through a second duct comprises:
passing the vapor product across the electrode to allow at least a portion of liquid particles present within the vapor product to collect on the electrode, wherein the collection of the liquid particles selectively separates from the electrode such that the combination of the collection of liquid particles.

21. The method according to any of the preceding claims, further comprising:
collecting the liquid particles selectively separated from the vapor product and transferring the collected liquid particles to a reservoir.
